(19) United States
(12) Patent Application Publication
(10) Pub. No.: US 2008/0295386 A1
(43) Pub. Date: Dec. 4, 2008

(54) Slip weight for a fishing line

(76) Inventor: Gordon Wayne Hudson, Vista, CA (US)

Correspondence Address: William C. Fuess;Suite 2G, 10951 Sorrento Valley Road, San Diego, CA, 92121-1613, US

(21) Appl. No.: 11/807,606

(22) Filed: May 31, 2007

(51) Int. Cl. A01K 95/00

(52) U.S. Cl. 43/44.91

(57) ABSTRACT

A slip-on weight 1 for a fishing line includes a weighted body 11 and an elongate member 12. The body 11 has an overall specific gravity greater than one, a central borel 111 having a slightly greater diameter at its proximal end 112 and a slightly lesser diameter at its distal end 113, and (3) a slot 114 from the exterior of the body to its central bore 111. The elongate member 12 is in the substantial shape of a hollow tube with (1) its distal end 123 diameter slightly greater than its proximal end 122 diameter, and with (2) a longitudinal slot 124 connecting to the interior of the tube. This member 12 is pressed into the distal end 113 of the bore 111 so as become rotationally maintained therein and extending there through, the larger proximal-end diameter of the elongate member 12 being within and complimentary to the larger diameter of the proximal-end of the bore 111 of the body 111 while the lesser diameter of the elongate member 12 is within and complimentary to the lesser diameter of the bore 111 of the body 11. So situated the elongate member 12 is manually rotatable within the bore 111 of the body 11 between a first position where its slot is aligned with the slot 114 of the body 11 so as to accept fish line 2 inserted though both slots and into a central hollow to both the body 11 and the member 12, and a second position where inserted fish line 2 within the central hollows of the body 11 and the member 12 is captured.

### BACKGROUND OF THE INVENTION

1. Field of the Invention

The present invention pertains to the field of fishing accessories. More particularly, it pertains to fishing weights, of the type known as “slip sinkers,” which are applied to a fishing line to (1) submerge a fishing lure or bait attached to the line to various depths in a body of water, while (2) allowing the line to slide freely through the body of the weight. Still more particularly, the invention pertains to a slip sinker of improved manufacturability and performance.

2. Description of the Prior Art

The present invention is related as an improvement to the invention of U.S. Pat. No. 5,784,828 to Thompson for a slip-on fishing weight The Thomson patent concerns a weight for a fishing line, including a weighted body defined by an outer surface. This body has (1) an overall specific gravity greater than one, (2) forward and rearward end portions in spaced-apart arrangement aligned along a longitudinal central axis, (3) an axial bore formed in the body and passing there through serving to interconnecting the forward and rearward end portions, and (4) an elongated hollow tube pivotally mounted in and concentrically aligned in the axial bore, and terminated by first and second distal ends. The body and the tube each have formed therein (5) a radial slot extending along the entire length thereof and extending outward from the central axis for receipt therein of a fishing line.

A first device exterior to the first distal end portion of the tube extends outward from the tube for turning the tube in the body in order to rotate the tube slot to a position relative to the radial body slot. A second device cooperates with the first device for retaining the tube in the body. These exterior devices at each end are both (1) troublesome of manufacture, being preferably made of metal of greater radial extension than in a metal bore though which at least one must slip during manufacture of the slip-on fishing weight, and (2) problematic to performance of the sip-on fishing weight during use in fishing in that both ends induce such turbulence in water flowing around the weight as may scare fish. These limitations of this prior art fishing weight of Thompson are further discussed after an explanation of (1) the requirement for a slip-on fishing weight, and (2) other, more general, prior art regarding such weights.

As described in the Thompson patent, using a slip sinker to submerge a fishing lure or baited hook attached to one's fishing line is a long-standing and well-known fishing technique. The primary advantage of using a slip sinker is that it permits a fish to pick up the lure or bait in its mouth and “run” with it for a short distance prior to swallowing it. Running with the lure or bait is a common behavior of many species of fish. It is thought that perhaps fish often behave in this manner in order to keep the lure or bait from the mouths of competing fish located nearby.

Where the sinker is tied directly to the line, the fish feels its resistance almost immediately and often drops the lure or bait in alarm. The slip sinker eliminates this resistance and gives a fisherman a better chance to “set the hook” in the fish's mouth during the run. The slip sinker slips along the fishing line, and is ultimately only stopped by a split shot attached to the fishing line at a position before the hook or, if no such split shot or other “stop” is present, the fishing hook itself.

Meanwhile, those who practice the art of fishing are well-aware of the problems associated with having to cut, rethread, and retie one's fishing line in order to change the weight or size of a slip sinker.

A common problem associated with fishing with slip sinkers is the time wasted in cutting, rethreading, and retying one's line in placing the weight on the line or in order to change the weight. This problem can be particularly annoying and troublesome for people who participate in fishing tournaments, as it is often necessary to quickly change or add weight to one's fishing line. The time lost by having to cut, rethread, and retie one's fishing line in order to add or change weight can mean the difference between winning or losing a big tournament.

A second problem which many people, such as young children or first-time fishermen, encounter is that they do not know how to properly tie a fishing knot or they have a great deal of difficulty leaming to tie knots. A few days spent trying to tie knots, or losing fish because of poorly tied knots, can frustrate and discourage even the most enthusiastic beginner. Poorly tied knots are a frequent reason for losing fish.

Even the best and fastest knot tiers can have difficulty tying knots on cold, wet, and windy days. Trying to tie a knot with wet, slippery hands that are stiffened because of cold, windy, and rainy weather—a common situation for many fishermen—is seldom enjoyable. On some raw mornings, such a task is effectively impossible for the most die-hard fishermen.

Litter is another problem associated with using slip sinkers. Often, when one cuts his or her line to change weight, bits of cut line get into the water and/or onto the ground, littering the beautiful outdoors and presenting a danger to fish. Fish that get caught in tangles of line thrown into the water by fishermen often die.

Although the prior art discloses various types of fishing weights, including slip sinkers, none of the inventions disclosed overcome all of the above-mentioned problems. U.S. Pat. Nos. 778,669, 2,137,341, 3,628,279, 4,649,663, 5,157,860—as well as the aforementioned U.S. Pat. No. 5,784,828—are typical of the prior art.

U.S. Pat. No. 778,669 discloses a fish line float of elongated hydrodynamic design having a radial slot formed along the body for receipt therein of a fishing line. A pin is inserted in each end of the float, each pin having a loop at the exterior distal end thereof. The fishing line in the slot is thereafter threaded through the loops to hold the float in place on one's line. This invention does not allow slippage of the float even though the line need not be cut to put on or take off the float.

U.S. Pat. No. 2,137,341 discloses a float-popper having a central bore through which a fishing line is passed and then tethered therein by insertion of a tapered pin along the central axis. Again, this invention allows for addition of the float to the line without separating the line but does not allow slippage of the float along the line thereafter.

U.S. Pat. No. 3,628,279 discloses a fish lure retriever having a lengthwise slot formed in an outer circular metal casing and a radial slot formed in an inner tapered resilient plug that is adapted to slide partially in and out of the casing. The fishing line is slipped through both slots to mount the retriever on the line and then the retriever is lowered into the water to contact a snagged lure for recovery. Although this invention does not require any cutting or tying of the line, it does involve rethreading. More importantly however, this invention does not address any of the problems associated with fishing weights, because it is used to retrieve snagged lures.

U.S. Pat. No. 4,649,663 discloses a slip sinker that contains a centralized plastic sleeve to allow the sinker to move freely along the line without abrading the line. However, this invention requires cutting, threading, and tying of fishing line every time one wants to add or change weight and, thus, does not solve the problems of the prior art.

Finally, U.S. Pat. No. 5,157,860 discloses a sinker having a radial slot for receipt of a fishing line and then the slot is filled with a thin rubber or plastic insert to keep the sinker from falling off of the line. Although this invention can be used as a slip sinker, by partially inserting the plastic or rubber insert into the weight, and does not require any cutting, threading, or tying, this invention does not overcome all of the problems associated with slip sinkers. In fact, this invention can create more problems for fishermen.

For example, the insert must be pried out of the weight each time one wants to change or add weight. Furthermore, if one wants to use the weight as a slip sinker, one must be careful not to reinsert the insert too far. Pushing the insert into the weight too far could cause the weight to be wedged tightly against the line which would inhibit or prevent the line from moving freely through the body of the weight, thus, causing the weight to not function like a slip sinker. Such an adjustment of the insert is time-consuming and does not solve the tournament fisherman's problem of the need for speed in changing or adding weight.

This patent also does not overcome the problem of changing weight when ones hands are cold, wet, and slippery. In order to add or change weight, one must pry out and push in the insert, which can be a painful and frustrating experience for one with cold, stiff fingers. Furthermore where cold weather causes finger dexterity to be limited it can be difficult to hold and coordinate three separate parts (e.g., the line, the insert and the weight).

In addition, because this invention is comprised of two parts, there is a risk that the parts will become separated and lost during prying, reinsertion, casting, or when being dragged through weeds.

Returning now to the slip-on fishing weight of U.S. Pat. No. 5,748,828 to Thompson, this weight comprises a rotatable tube within a body. Importantly to the present invention, the preferred tube is not only straight but is made of metal such as brass or the same metal of which body is made, and is preferably further possessed of a polished or smooth interior surface. This is stated to be so that, when both body and tube are made of the same metal, any electromotive force-caused corrosion is minimized or eliminated. Alas, (1) the preferably metal body has and defines a straight longitudinal bore in which fits the tube, while (2) the preferably metal elongate cylindrical tube that fits (and selectively rotates) within this bore is preferably terminated by first and second distal end features, or devices, located outside the body, that are of larger radial diameter than is the bore.

Indeed, a first device preferably includes at least one arm, or umbrella-like surface, extending outward from the first distal end of the tube and bent backward over the outer surface of the body. The surface may be engaged by the fingers for such turning of the tube within the body as is necessary to engage and retain a fishing line. This surface may preferably further include cooperative detent means formed in the exterior of the body and bump means formed in the tube for engagement to lock the slot in the tube in or out of alignment with the slot in the body. This constructed this first device cannot be, and is not, insubstantial (relative to other parts, and to the tube of which it is itself a part) being that it must (1) present a surface to the fingers and (2) be mechanically strong enough to effect turning of the tube within the bore of the body.

The second device at the second distal end of the tube is preferably but a simple outward flare formed in the end of the tube. This outward flare is preferably complimentary to a cavity within rearward end portion of the body. Nonetheless to being of simple construction, this flare to the tube also is necessarily of greater diameter than is the bore of the boy else the entire tube would slip through the body, and would not only fail to retain the fishing weight to a fishing line but would, indeed, simply cause that the fishing weight in both its body and tube components would fall from the line.

According to the first and second distal end features, or devices, of the tube that are both of greater diameter than is the bore of the body through which at least one must fit during manufacturing assembly of the fishing weight, an impossible situation, or at least a severe problem, is presented. Due to the complexity of the features and the close tolerances, neither feature is readily susceptible of being formed in situ from metal after assembly. Further, if it is hypothesized that, contrary to Thompson's stated preference for metal, that one of the tube of body should be made of deformable plastic, then also it may be found that the features are of such size and function as make it unlikely that they could be both (1) assembled and (2) thereafter fully functional.

Still further, in use of the Thompson slip-on fishing weight these same distal end features may cause turbulence during trolling or retrieving of a lure, and this may scare fish from biting.

Therefore none a readily manufactured, and reliably functioning, slip-on fishing weight, or simply slip sinker, is desired.

### SUMMARY OF THE INVENTION

The present invention is a slip-on fishing weight, or slip sinker, for attachment to a fishing line in order to submerge the fishing lure and/or any attached bait in a body of water, the sinker being readily manufactured in two parts, and reliably smoothly functional in use without any cutting, threading, or tying of fishing line in order to add weight to, or change the weight on, the line.

In its most preferred embodiment a slip-on weight for a fishing line in accordance with the present invention basically includes only the two components of (1) a body and (2) an elongate element.

The body has (1) an overall specific gravity greater than one, (2) a central bore having a slightly greater diameter at its proximal end and a slightly lesser diameter at its distal end, and (3) a slot from the exterior of the body to its central bore; It is normally made from any material with a specific gravity greater than one, preferably (1) lead or lead alloys, (2) glass or (3) ceramics.

The elongate element has the substantial shape of a hollow tube with (1) its distal end diameter slightly greater than its proximal end diameter, and (2) a longitudinal slot connecting to the interior of the tube, that is (3) pressed into the distal end of the bore so as become rotationally maintained therein and extending there through. The larger diameter of the tube is within and complimentary to the larger diameter of the bore while the lesser diameter of the tube is within and complimentary to the lesser diameter of the bore. The tube is manually rotatable within the bore between a first position where its slot is aligned with the slot of the body so as to accept fish line inserted though both slots and into a central hollow to the tube and a second position where inserted fish line within the central hollow of the tube is captured by the body.

The elongate element is preferably molded from plastic, and more preferably from strong plastics including polypropylene. It may alternatively be made from such nylon as is not susceptible to swelling in salt water.

By this construction, and this co-action, the slip-on weight is able to (1) accept fish line into the slot of the elongate element and the bore of the body, (2) slip the fish line longitudinally though the slot of the elongate element and the bore of the body in the event of rapid line movement as may be caused by a fish strike, and (3) release the accepted fish line.

The slip-on weight for a fishing line preferably further includes a feature upon the proximal end of the bore that is both external to the bore of the body when the elongated element is pressed therein and suitably grabbed with the fingers to rotate the elongate element within the bore of the body. The tube is thus located at its first and at its second positions under force of the fingers.

In the most preferred embodiment of the slip-on weight for a fishing line the interior diameters of the bore of the body are equal within 10%, and the complementary exterior diameters of the elongate element are likewise equal within 10%.

The body is preferably made of metal, and more preferably from lead or lead alloys. The elongate element is preferably made of plastic, and more preferably polypropylene.

In the preferred shape of the slip-on weight for a fishing line, the body is an oblate spheroid with a longitudinal central bore. There is preferably a circumferential shoulder, most preferably a square shoulder, or like feature of low height, preferably less than one fifth and more commonly less one-tenth the diameter of the bore, within the bore, preferably located at about one-hald the length of the bore. The bore may also have and present a small recess, on the order of a shallow hole, that will serve, in combination with a complimentary raised feature on the slotted elongate member, as a detent.

The slotted elongate member likewise has a shoulder of complimentary contour (e.g., square), dimension (e.g., of small height), and position (e.g., halfway along its length). To the shoulder within the bore of the oblate spheroid, When the elongate member is longitudinally pressed within the bore of the oblate spheroid, it is subsequently rotatably permanently retained therein. A raised “pimple” on the surface of the slotted elongate member is likewise complimentary with the shallow hole in the bore of the oblate spheroid to for a detent resisting rotation of the elongate member when engaged.

These and other aspects and attributes of the present invention will become increasingly clear upon reference to the following drawings and associated specification.

### BRIEF DESCRIPTION OF THE DRAWINGS

FIG. 1, consisting of FIGS. 1a and 1b, are perspective views of a slip-on weight for a fishing line in accordance with the present invention respectively in its assembled, and dis-assembled, condition.

FIG. 2a is a proximal end plan view, FIG. 2b is a side plan view, and FIG. 2c is a distal end plan view of the body of the slip-on weight for a fishing line in accordance with the present invention previously seen in FIG. 1

FIG. 3 is a sectional view, taken along aspect line A-A of FIG. 2c, of the body of the slip-on weight for a fishing line in accordance with the present invention previously seen in FIGS. 1 and 2.

FIG. 4 is a sectional view, taken along aspect line B-B of FIG. 3, of the body of the slip-on weight for a fishing line in accordance with the present invention previously seen in FIGS. 1, 2 and 3.

FIG. 5 is a perspective view of the elongate member of the slip-on weight for a fishing line in accordance with the present invention previously seen in FIG. 1 in a position outside the body previously seen in FIGS. 2-4.

FIG. 6a is a proximal end plan view, FIG. 6b is a side plan view, and FIG. 6c is a distal end plan view of the elongate member of the slip-on weight for a fishing line in accordance with the present invention previously seen in FIG. 1 in a position outside the body previously seen in FIGS. 2-4.

FIG. 7, consisting of FIGS. 7a through 7d, are side views of alternative embodiments of the elongate member, previously seen in FIGS. 5 and 6, of the slip-on weight for a fishing line in accordance with the present invention previously seen in FIG. 1.

FIG. 8, consisting of FIGS. 8a through 8c, are perspective views of the use and action of the slip-on weight for a fishing line in accordance with the present invention previously seen in FIG. 1.

### DESCRIPTION OF THE PREFERRED EMBODIMENT

A slip-on weight for a fishing line, or slip sinker, in accordance with the present invention may have many different shapes, for example a small, “bullet”-shaped weight. However, more rounded shapes, such as those known as “egg-shaped” weights are common for fishing weights, and are adapted for the preferred embodiment of the present invention. The shape, weight, size, and color of a slip sinker in accordance with the present invention may vary to a great extent. Depending upon the circumstances, such as the type and size of fish being fished for, the fishing technique being used, weather conditions, water depth, current, line test, and underwater environment, it may be more or less desirable to a use certain variations of the slip sinker.

For instance, on a warm, calm, summer day, when fishing with light line for bass in a heavily weeded area, along the shoreline of a lake, it may be desirable to use a small black ⅛ ounce bullet-shaped slip sinker in combination with a rubber worm. However, if one is fishing with heavy line for large catfish at the bottom of a deep channel in a lake or river with a strong underwater current, it may be desirable to use the typically heavier, egg-shaped variation of the slip sinker that is shown in the drawings.

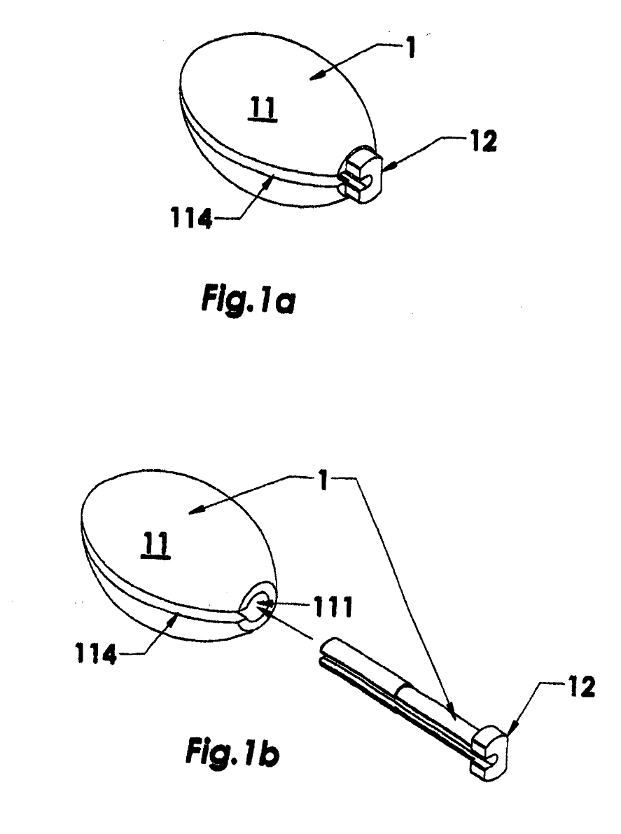

Turning now to the drawings, where like elements are identified by like numbers throughout the seven drawings, FIG. 1 shows the preferred embodiment 1 of the present invention and shows it to comprise a weighted body or sinker 11 having a central bore 111 in which is contained a rotatable elongate member 12. The body 11 is preferably homogeneous in composition and has an overall specific gravity greater than one. It is preferably made of metal or glass or ceramic, and more preferably as a malleable metal such as, most preferably, lead or a lead alloy. It may in particularly be made by molding.

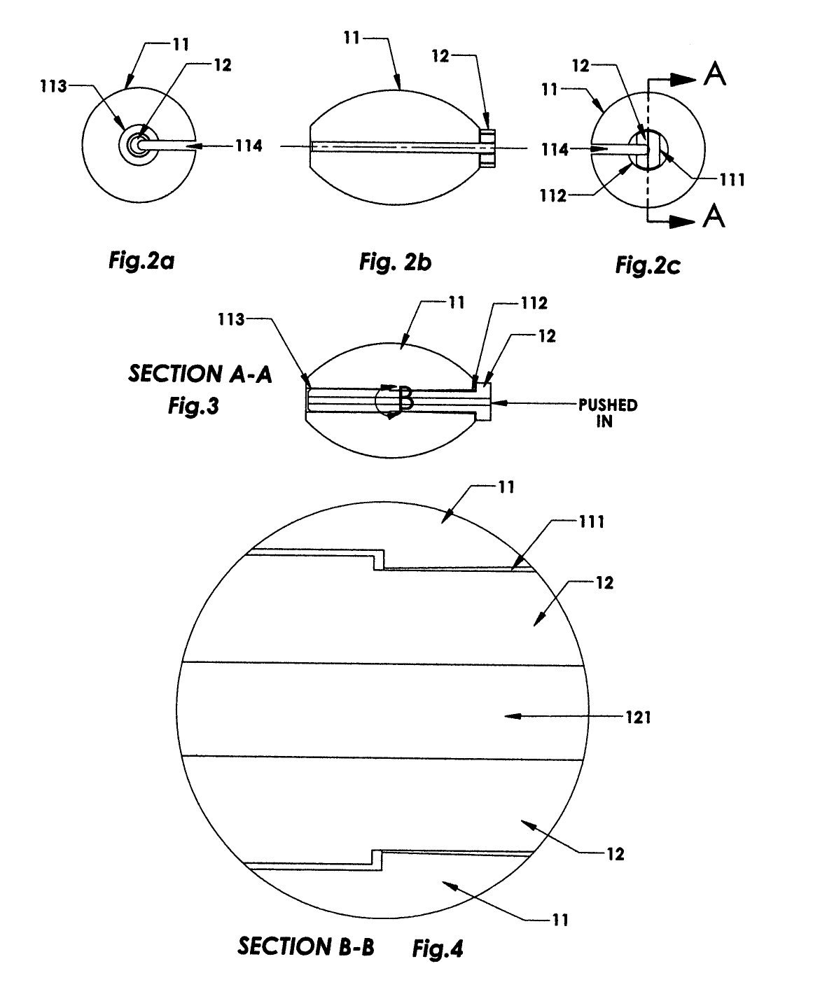

The body 12 is has both a proximal end 112 and a distal end 113 as are best respectively illustrated in FIGS. 2a and 2c. These end regions 112, 11 are respectively in spaced-apart arrangement and aligned along a longitudinal central axis. The body 11 is bulbous in the form of the commonly known egg-shaped fishing weight.

As best shown in FIGS. 2a-2c, body 11 has an axial bore 111 formed therein and passing there through serving to interconnect proximal and distal end regions 112 and 113. An elongate member 12 in the form of an elongated hollow tube is pivotally mounted in and concentrically or axially aligned within the axial bore 111. This tube-shaped elongate member 12 has, likewise to the body 11, a central bore 121, a proximal end 22, and a distal end 23.

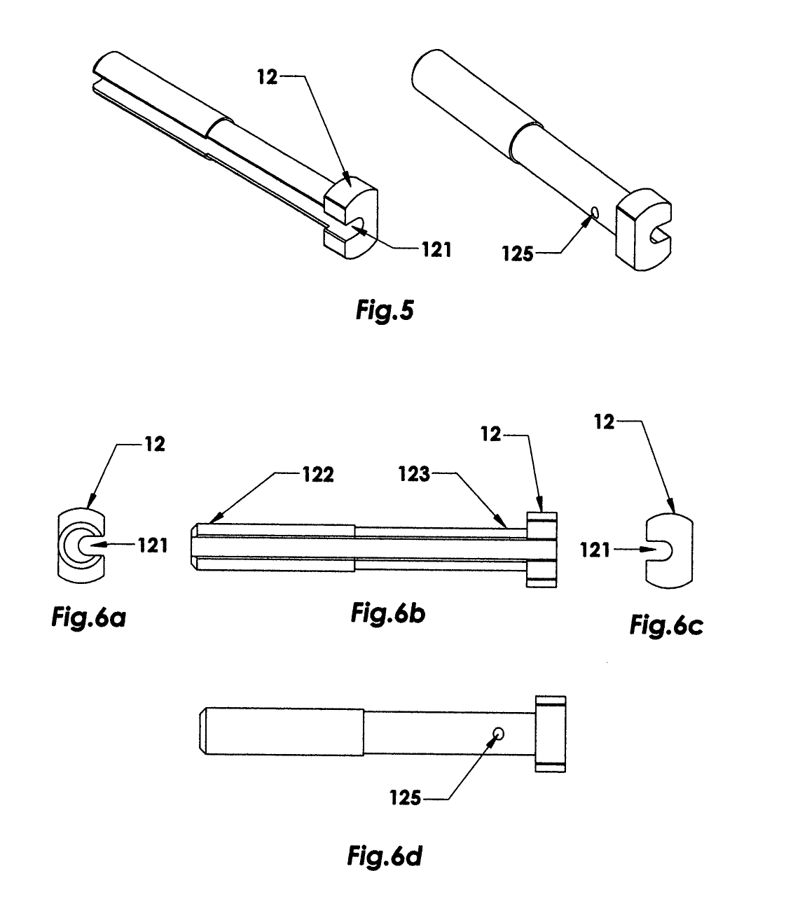

As is respectively best shown in FIGS., 2b and 6b, both body 11 and longitudinal element 12 each have formed therein a respective radial slot 111, 121 respectively that extend along the entire length of each the body 111 and the elongate member 121, and outward from their common central axis, for receipt there through of a fishing line 2 (shown in FIG. 5, not part of the present invention).

It is preferred that elongate member 12 in the shape of a hollow tube is straight and passes straight through body 11 so that the resistance to movement of the fishing line through tube of the elongate member 12 (and the body 11) is minimized. It is further preferred that elongate member 12 is not only straight but that it is made of plastic, and it is still further preferred that it should be made of polypropylene. It may likewise be fabricated by molding, and may further have a smooth finish so as to present a smooth surface to the bore 111 of body 11, although this is normally not necessary for correct function. Between body 11 and elongate member 12 any electromotive force-caused corrosion is minimized or eliminated because one of the body 11 and elongate member 12 is made of plastic, more preferably the elongate member 12.

Either the proximal end 123, or the distal end 122, or both the proximal and distal ends 123, 122 of the elongate member 12 may extend beyond the bore 111 of the body 11. However, for purposes of assembly only one such end of elongate member 12 may be of larger diameter than the bore 111, illustrated in the figures to be its distal end 122.

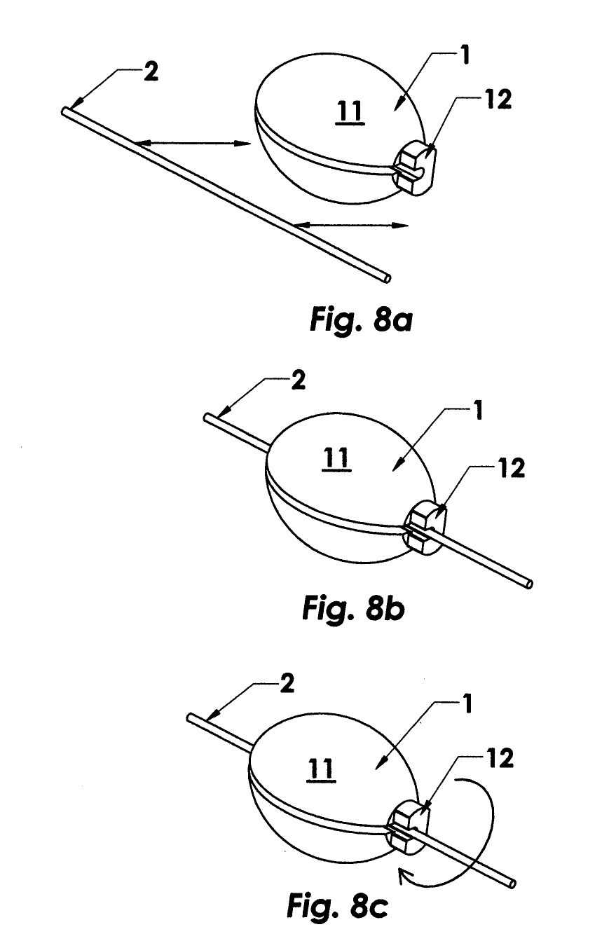

The distal end 122 of the elongate member 1d is located exterior distal end 111 of the body 11, and, extending outward from the body 11, permits the turning of the elongate member 12 within the bore 111 of the body 11. This turning occurs by a grasping with the fingers (not shown) to turn by hand the outside diameter of the distal end 122 the elongate member 12 so as to bring its slot 124 into and out of mutual alignment with the complimentary slot 114 of the body 11. This surface may optionally be knurled (not shown). It is by this turning that a fishing line 2 (shown in FIG. 8) is captured, or released.

It is preferred that radial slot 114 in the elongate member 11 should be wider than the fishing line 2 on which slip sinker of the present invention is used. This allows body 11 to be easily slipped onto and off of the fishing line 2. Of course, it is also preferred that radial slot 124 in body 12 be wider than the fishing line for the very same reason. As best shown in the detail cross-section, views of FIGS. 3 and 4, the interior bore 111 of the body 11, and the exterior of the elongate member 12, are of slightly different diameters in their proximal, and distal regions. These diameters are close enough, normally within 10% for each element and also within 10% between elements, that the elongate member 12 may be press fit into the bore 111 of the body 11, proximal end 123 of the elongate member 12 passing into the distal end 113 of the body 11. One inserted the larger portion of the elongate member 12 fits within the larger portion—shown to the left in FIG. 4—of the bore 111 of the body 11

The elongate member 12 thus becomes is pinned between its distal and proximal ends 122, 123 and inside the bore 111 of the body 11 where it is available for rotational movement but not translational movement vis-à-vis the body 11. The elongate member 12, as already explained, preferably made from a stiff material such as plastic.

A detent 125, best seen in FIGS. 5 and 6d, resists when engaged rotation of the elongate member 12 within the bore 111 of the body 11. This, and many like alternative features. suffice to retain elongate member 12 both for extraction from, and for rotation within, the bore 111 of body 11.

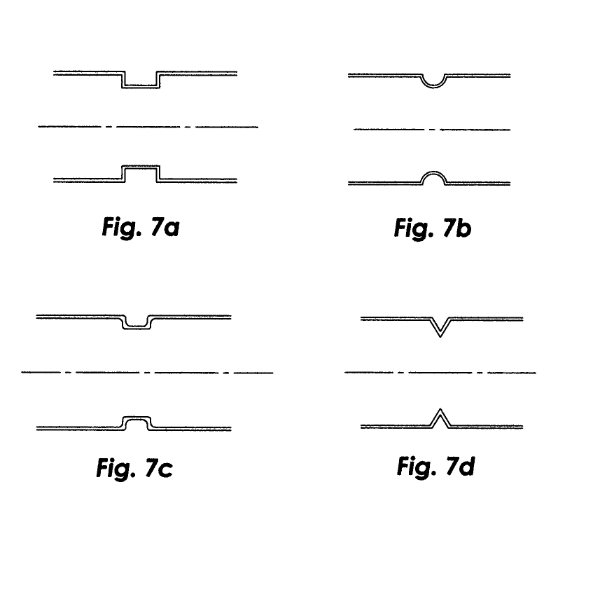

Additional features as resist the longitudinal extraction of the elongate member 12 from the bore 11 of the body 11 are illustrated in FIG. 7, consisting of FIGS. 7a through 7d. Each figure shows a side view of an alternative embodiment of the elongate member 12, previously seen in FIGS. 5 and 6, fit within a complementary bore 111 of the body 11. Together the body 11 and elongate member 12 form the slip-on weight for a fishing line in accordance with the present invention.

This two-element slip-on weight previously seen in FIG. 1 is shown in use in FIG. 8, consisting of FIGS. 8a through 8c. Each figure is a perspective view of the use and action of the slip-on weight for a fishing line in accordance with the present invention. A fishing line 2 (not part of the invention) is slid sideways into or out of the weight 1 in FIG. 8a, lodged in the central bore in FIG. 8a, and retained or released (as the case may be) by rotation of the elongate element 12 within the body 11 as shown in FIG. 8b.

The elongate member 12 may be rotated in the body 12 either so as to confine a fishing line substantially along a central axis of the slip weight while allowing the line to move freely through the center of the body 11 of the slip weight 1, or clearances can be made tight enough so that the “slip” weight 1 actually “grabs” the line 2.

Accordingly, the main object of this invention is a versatile and inexpensive universal “slip sinker” fishing weight that is feasibly, and, indeed, readily manufactured and assembled, The slip weight can be attached and removed from one's line quickly and easily without having to cut, thread, or tie the line to a lure or hook. Other objects of the invention include a sinker to provide tournament fishermen with a quick and easy means of adding or changing the size, weight, color, and shape of the weight on their fishing line, thereby preventing wasted time, caused by cutting, threading, and tying of line, where time is of the essence and often critical to tournament success; a means of allowing beginning or inexperienced fishermen a quick and simple way to add or change the size, weight, shape, color, and amount of weight on his or her fishing line without having to cut, thread, or tie the line, thereby making one's fishing experience more enjoyable; a means of making it easier and quicker for fishermen to change or add weight to their fishing line when their hands are cold, wet, and slippery and their finger dexterity is limited due to cold, windy, and/or rainy weather; and a means to reduce fishing line litter caused by the careless discarding of bits of cut line, thereby helping to keep the outdoors beautiful and helping to maintain a safe environment in which fish can live. These and other objects of the invention will become more apparent upon reading the following description of the preferred embodiment taken together with the drawings appended hereto.

While the invention has been described with reference to a particular embodiment thereof, those skilled in the art will be able to make various modifications to the described embodiment of the invention without departing from the true spirit and scope thereof. It is intended that all combinations of elements and steps which perform substantially the same function in substantially the same way to achieve substantially the same result are within the scope of this invention.

What is claimed is:

1. A slip-on weight for a fishing line comprising:
a weighted body having (1) an overall specific gravity greater than one, (2) a central bore having a slightly greater diameter at its proximal end and a slightly lesser diameter at its distal end, and (3) a slot from the exterior of the body to its central bore;
an elongated element in the substantial shape of a hollow tube with (1) its distal end diameter slightly greater than its proximal end diameter, and (2) a longitudinal slot connecting to the interior of the tube, that is (3) pressed into the distal end of the bore so as become rotationally maintained therein and extending there through, the larger diameter of the tube being within and complimentary to the larger diameter of the bore while the lesser diameter of the tube is within and complimentary to the lesser diameter of the bore, (3) the tube being manually rotatable within the bore between a first position where its slot is aligned with the slot of the body so as to accept fish line inserted though both slots and into a central hollow to the tube and a second position where inserted fish line within the central hollow of the tube is captured by the body;

2. The slip-on weight for a fishing line according to claim 1 further comprising:
a feature upon the proximal end of the bore that is both external to the bore of the body when the elongated element is pressed therein and suitably grabbed with the fingers to rotate the elongate element within the bore of the body;
wherein the tube is locatable at its first and at its second positions under force of the fingers.

3. The slip-on weight for a fishing line according to claim 1
wherein the interior diameters of the bore of the body are equal within 10%; and likewise,
wherein the complementary exterior diameters of the element are equal within 10%.

4. The slip-on weight for a fishing line according to claim 1
wherein at least one of the body and the element is made of metal.

5. The slip-on weight for a fishing line according to claim 4
wherein the body is made of metal; and
wherein the element is made of plastic.

6. The slip-on weight for a fishing line according to claim 1
wherein one of the body and the element is made of metal and the other is made of plastic.

8. The slip-on weight for a fishing line according to claim 1
wherein the body is an oblate spheroid with a longitudinal central bore.
